(19) United States
(12) Patent Application Publication
(10) Pub. No.: US 2011/0119347 A1
(43) Pub. Date: May 19, 2011

(54) METHOD AND APPARATUS FOR MANAGING CONTENT

(75) Inventors: Keum-koo LEE, Seongnam-si (KR); Soo-hong Park, Yongin-si (KR); Jin-guk Jeong, Yongin-si (KR); Hee-jeong Choo, Anyang-si (KR); Ju-yun Sung, Yongin-si (KR); Ji-young Kwahk, Seongnam-si (KR)

(73) Assignee: Samsung Electronics Co., Ltd.

(21) Appl. No.: 12/946,362

(22) Filed: Nov. 15, 2010

(30) Foreign Application Priority Data
Nov. 13, 2009 (KR) 10-2009-0109445

(51) Int. Cl. G06F 9/46; G06F 15/16

(52) U.S. Cl. 709/217; 719/318

(57) ABSTRACT

An apparatus and method for managing content, wherein the method includes determining an event to occur, based on user metadata, selecting content corresponding to the event, selecting an external device to reproduce the content, and then generating binding information about a binding between the event, the content, and the external device.

### PRIORITY

This application claims priority under 35 U.S.C. §119(a) to Korean Patent Application No. 10-2009-0109445, which was filed in the Korean Intellectual Property Office on Nov. 13, 2009, the entire disclosure of which is hereby incorporated by reference.

### BACKGROUND OF THE INVENTION

1. Field of the Invention

The present invention relates generally to a method and apparatus for managing content, and more particularly, to a method and apparatus for providing content to an external device.

2. Description of the Related Art

With the rapid development in the Information Technology (IT) field, large amounts of content are available to users of Consumer Electronic (CE) devices. However, the users have to search through these large amounts of content in order to locate desired content.

Additionally, as various types of CE devices are available, the user also has to check a content type that is reproducible in each of the CE devices, and then search for and obtain the reproducible content.

### SUMMARY OF THE INVENTION

Accordingly, the present invention has been designed to address the above-mentioned problems occurring in the prior art, and the present invention provides a method and apparatus for managing content, in order to transmit user desired content to an appropriate external device.

According to an aspect of the present invention, a method of managing content is provided. The method includes determining an event to occur in a future, based on user metadata; selecting content corresponding to the event; selecting an external device to reproduce the content; and generating binding information about binding between the event, the content, and the external device.

According to another aspect of the present invention, a content managing apparatus is provided. The apparatus includes an event determination unit for determining an event to occur in a future, based on user metadata; a selection unit for selecting content corresponding to the event, and selecting an external device to reproduce the content; and a generation unit for generating binding information about binding between the event, the content, and the external device.

### BRIEF DESCRIPTION OF THE DRAWINGS

The above and other aspects, features, and advantages of certain embodiments of the present invention will become more apparent the following detailed description with reference to the attached drawings, in which:

FIG. 1 is a block diagram illustrating a content managing apparatus according to an embodiment of the present invention;

FIG. 2 is a diagram illustrating user metadata according to an embodiment of the present invention;

FIG. 3 is a diagram illustrating content metadata according to an embodiment of the present invention;

FIG. 4 is a diagram illustrating device metadata according to an embodiment of the present invention;

FIG. 5 is a diagram illustrating device metadata according to an embodiment of the present invention;

FIG. 6 illustrates an example of operations performed by a content managing apparatus according to an embodiment of the present invention;

FIG. 7 illustrates an example of operations performed by a content managing apparatus according to an embodiment of the present invention;

FIG. 8 illustrates an example of binding information, according to an embodiment of the present invention; and

FIG. 9 is a flowchart illustrating a method of managing content, according to an embodiment of the present invention.

### DETAILED DESCRIPTION OF EMBODIMENTS OF THE INVENTION

Hereinafter, various embodiments of the present invention will be described in detail with reference to the attached drawings. In the following description, the same elements will be designated by the same reference numerals although they are shown in different drawings. Further, a detailed description of known functions and configurations incorporated herein will be omitted when it may obscure the subject matter of the present invention.

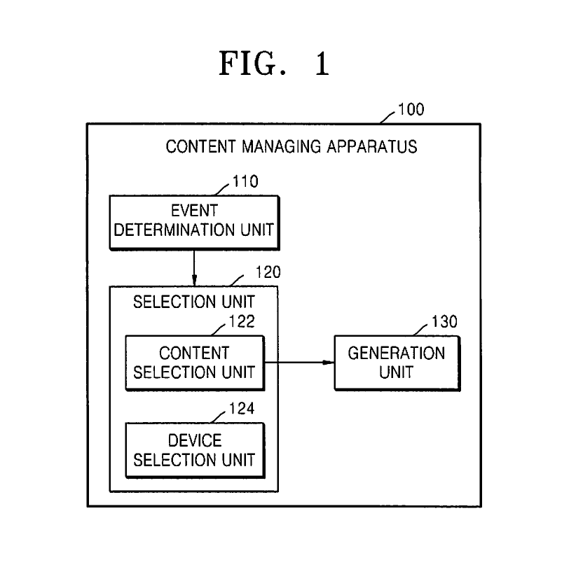

FIG. 1 is a block diagram illustrating a content managing apparatus 100 according to an embodiment of the present invention.

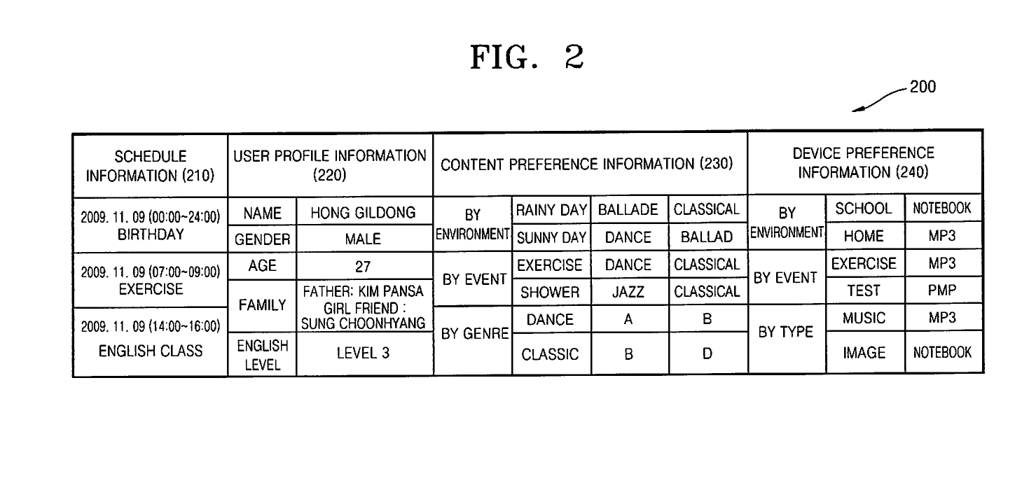

Referring to FIG. 1, the content managing apparatus 100 includes an event determination unit 110, a selection unit 120, and a generation unit 130. The event determination unit 110 determines an event to occur in the future, based on user metadata including any information about a user. For example, the user metadata may include user schedule information, user profile information including personal information of the user, content preference information, i.e., information about user preferred content, and device preference information, i.e., information about a user preferred device. A more detailed example of user metadata will be described later with reference to FIG. 2.

The event determination unit 110 may check the event to occur in the future by using the user schedule information. However, the event determination unit 110 may also predict the event to occur in the future without using the user schedule information. For example, when the user regularly performs a specific event, and such information is included in the user metadata, the event determination unit 110 may predict an event to be performed by the user. More specifically, if the user metadata includes information indicating that the user goes jogging at 9:00 AM each day, the event determination unit 110 may predict that a “jogging event” will occur “tomorrow at 9:00 AM”.

The selection unit 120 selects content corresponding to an event, and selects an external device to reproduce the selected content. The selection unit 120 includes a content selection unit 122 and a device selection unit 124.

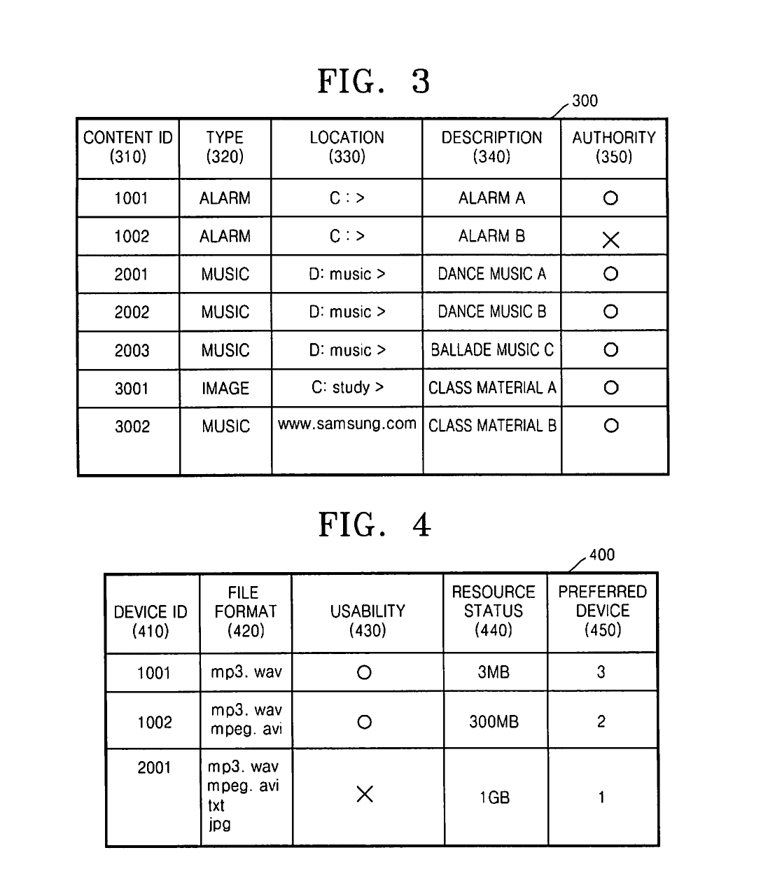

The content selection unit 122 selects the content corresponding to the event, based on at least one of the user metadata and content metadata. The content metadata may include any information about content. For example, the content metadata may include IDentification (ID) information about usable content, storage location information about the usable content, authority information about the usable content, and content type information. A more detailed example of the content metadata will be described later with reference to FIG. 3.

Additionally, the content selection unit 122 may include a type determination unit (not shown) and a content determination unit (not shown). The type determination unit determines a type of the content corresponding to the event, according to the user metadata.

For example, when the event determination unit 110 determines the event to occur in the future as an “English test”, and the user metadata includes information indicating that an English level of the user is “level 3”, the type determination unit determines the type of the content corresponding to the “English test” event as a “file related to English” corresponding to “level 3”.

In another example, when the event determination unit 110 determines the event to occur in the future as “exercise”, and the user metadata includes information indicating that the user prefers “dance music” for exercising, the type determination unit determines the type of the content corresponding to the “exercise” event as “dance music”.

When a type of content is determined, the content determination unit selects at least one content corresponding to the determined type, based on the content metadata. When there is a choice of different content for the determined type, a content list may be provided to the user and for the user to select the final content, or final content may be automatically determined based on the user metadata.

The content determination unit searches for content corresponding to the type determined by the type determination unit based on at least one of the content ID information and the content type information, and then obtains the content using the content storage location information. The content storage location information may include, e.g., a Uniform Resource Locator (URL) address in an Internet network. In this case, the content managing apparatus 100 may receive the content determined by the content determination unit.

The device selection unit 124 selects a device to use the selected content, based on at least one of the user metadata and device metadata.

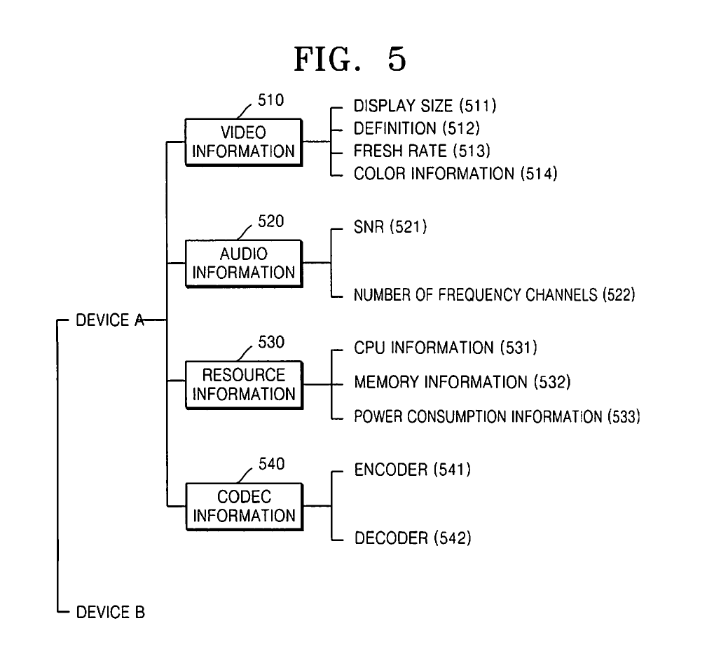

The device metadata may include any information regarding a device, e.g., at least one of ID information about a usable device, resource status information about the usable device, codec information about the usable device, video-type information about the usable device, and audio-type information about the usable device. More detailed examples of the device metadata will be described later with reference to FIGS. 4 and 5.

The device selection unit 124 identifies an external device capable of reproducing the content selected by the content selection unit 122, according to the device metadata. When one or more external devices are capable of reproducing the selected content, the device selection unit 124 may automatically select a user most-preferred device, based on the user metadata. Alternatively, the device selection unit 124 may present a list of available devices to user.

Although, the selection unit 120 illustrated in FIG. 1 includes a content selection unit 122 for selecting an event and a device selection unit 124 for selecting a device, for ease of description, a single unit can also perform these two selections.

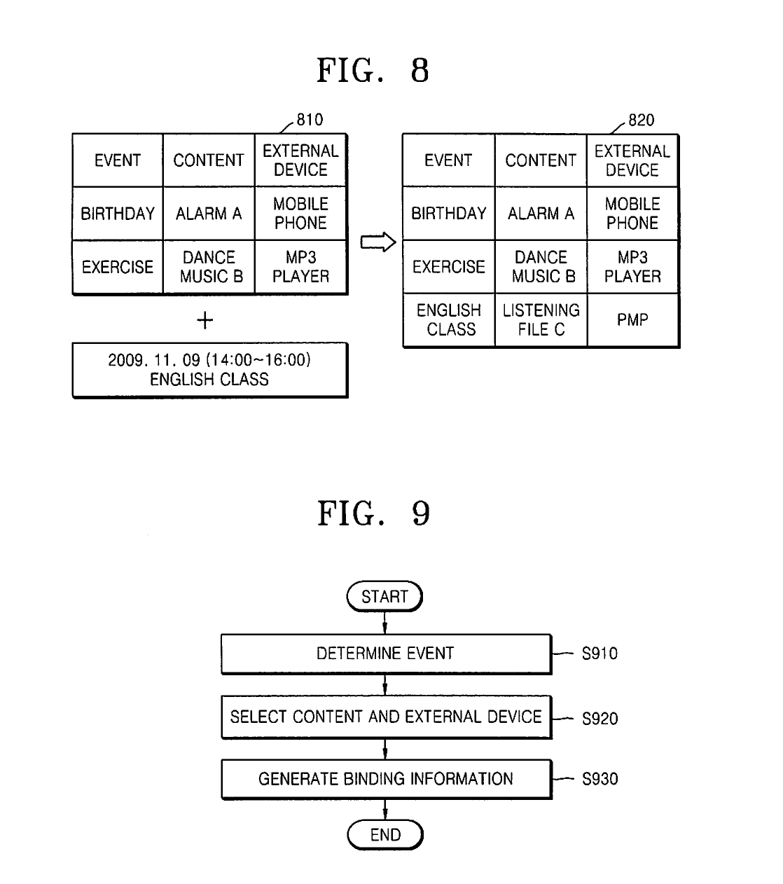

The generation unit 130 generates binding information about binding between the event, the content, and the external device. The binding information is updated whenever the event, the content, or the external device is generated (connection), deleted (removal), and changed (status change). A more detailed example of the binding information will be described later with reference to FIG. 8.

The content managing apparatus 100 may further include a transmission unit (not shown), which transmits the content to the external device based on the binding information. The transmission unit may be connected to the external device via a wired or wireless network. For example, the transmission unit may transmit the binding information to the external device, and then the external device directly obtains the content using the received binding information.

FIG. 2 is a diagram illustrating user metadata 200 according to an embodiment of the present invention.

Referring to FIG. 2, the user metadata 200 includes schedule information 210, user profile information 220, content preference information 230, and device preference information 240.

The schedule information 210 includes schedules that are directly recorded by a user, and/or includes schedules that are predicted by examining details of events that have been performed by the user.

The user profile information 220 includes personal information of the user, such as an age of the user, a gender of the user, a hobby of the user, a family of the user, friends of the user, a level of foreign languages, certificate information, etc.

The content preference information 230 includes information about user preferred content. For example, the user preferred content can be selected based on information about actors, directors, genres, production countries, etc., which are preferred by the user, or is selected based on a history of the content used by the user. The content preference information 230 may also include information about user preferred content selected according to various standards. In the example illustrated in FIG. 2, the user preferred content is selected according to ambient environments, events, and genres.

More specifically, referring to FIG. 2, the user further prefers ballad music on a rainy day, and further prefers dance music on a sunny day. When the user performs an “exercise” event, the user prefers “dance music”, and when the user performs a “shower” event, the user prefers “jazz music”.

With respect to the genres, the user further prefers a piece titled “A” from among dance music pieces, and further prefers a piece titled “B” from among classical music pieces.

The content selection unit 122 determines content as event content according to the content preference information 230, wherein the content is predicted for use by the user when an event occurs. For example, when an “exercise” event will occur tomorrow at 8:00 AM, the content selection unit 122 determines a “dance music piece A” as content corresponding to the “exercise” event because, according to the content preference information 230, the user prefers listening to “dance music” during an “exercise” event, and most prefers the “dance music piece A” from among dance music pieces.

The device preference information 240 includes information about a user preferred device. For example, the device preference information 240 may be generated based on a history of external devices used by the user. The device preference information 240 may indicate the user preferred device according to various standards. In the example of FIG. 2, user preferred devices are selected according to ambient environments, events, and content types.

More specifically, referring to FIG. 2, the user prefers a “notebook” device in a “school” environment, and prefers an “MPEG Audio Layer-3 (MP3)” device in a “home” environment. When the user performs an “exercise” event, the user prefers an “MP3” device, and when the user studies for a “test”, the user prefers a “portable multimedia player (PMP)” device. Also, the user prefers an “MP3” device for reproducing “music”, and prefers a “notebook” device for reproducing an “Image”, e.g., a movie or a photograph.

The device preference information 240 identifies a device capable of reproducing selected content, based on device metadata 400. When multiple devices are capable of reproducing the selected content, a user preferred external device is selected based on the device preference information 240. For example, when the “exercise” event will occur tomorrow at 8:00 AM, the content selection unit 122 determines the “dance music piece A” as the content corresponding to the “exercise” event. Because the user generally uses an MP3 device when the user exercises, the device selection unit 124 selects the MP3 device as an external device to reproduce the “dance music piece A”.

The content preference information 230 and the device preference information 240 may be included in the content metadata and the device metadata, respectively.

FIG. 3 is a diagram illustrating content metadata 300 according to an embodiment of the present invention.

Referring to FIG. 3, the content metadata 300 includes a content ID item 310, a type item 320, a location item 330, a description item 340, and an authority item 350. The content ID item 310 indicates content ID information, and the type item 320 indicates a type of content. The location item 330 indicates a position in which the content is stored. When the content is stored in an internal database, the location item 330 includes an address within the database. However, when the content has to be received from a website, the location item 330 includes a URL address of the corresponding website.

The description item 340 includes brief description information about the content, and the authority item 350 indicates an authority of a user. In the example illustrated in FIG. 3, when the authority item 350 displays “O”, this indicates that corresponding content may be used, modified, and deleted, when the authority item 350 displays “X”, this indicates that corresponding content may not be used, modified, and deleted, and when the authority item 350 displays “Y”, this indicates that corresponding content may be only used.

Referring to FIG. 3, content whose content ID is “2001” is a dance music file stored in a folder with a path of D:/music>. Also, because the authority item 350 displays “O” for this content, the user may freely use, modify, and delete the content.

FIG. 4 is a diagram illustrating device metadata 400 according to an embodiment of the present invention.

Referring to FIG. 4, the device metadata 400 includes a device ID item 410, a file format item 420, a usability item 430, a resource status item 440, and a preferred device item 450. The device ID item 410 indicates device ID information, and the file format item 420 indicates a file format that is reproducible in a device. The usability item 430 indicates whether it is possible to use a corresponding device. In particular, the usability item 430 indicates usability in relation to occurrence of a user event. For example, when the user event occurs on a street, a desktop computer is displayed as a usable device.

The resource status item 440 indicates an amount of resources allowed to be used by a device. For example, the resource status item 440 may include a size of a storage space allowed to be used by a corresponding device.

The preferred device item 450 indicates which device a user prefers. The preferred device item 450 may include information about the number of times that the user uses a corresponding device, or may include ranking information about corresponding devices.

As indicated above, the device selection unit 124 selects an optimum device according to each item included in the device metadata 400.

More specifically, the device selection unit 124 checks external devices connected to or registered in the content managing apparatus 100, based on the device ID item 410, in order to identify external devices capable of reproducing obtained content, based on the file format item 420. Thereafter, the device selection unit 124 checks an external device that is usable when a user event occurs, based on the usability item 430, and checks whether it is possible to store the obtained content in an external device, based on the resource status item 440.

If two or more external devices are capable of transmitting the obtained content, the device selection unit 124 makes a final selection of a device based on the preferred device item 450.

FIG. 5 is a diagram illustrating device metadata 500 according to an embodiment of the present invention.

Referring to FIG. 5, the device metadata 500 includes video information 510, audio information 520, resource information 530, and codec information 540. The video information 510 includes a display size 511, definition 512, a fresh rate 513, and color information 514, the audio information 520 includes a Signal-to-Noise Ratio (SNR) 521 and the number of frequency channels 522, and the resource information 530 includes Central Processing Unit (CPU) information 531, memory information 532, and power consumption information 533.

The codec information 540 indicates information about codecs supported by a corresponding device. The codec information 540 includes encoder type information 541 and decoder type information 542, which are related to an encoder and a decoder supported by the corresponding device. The encoder type information 541 and the decoder type information 542 may include video codec information, audio codec information, image codec information, and container information, which are used in the encoder and the decoder.

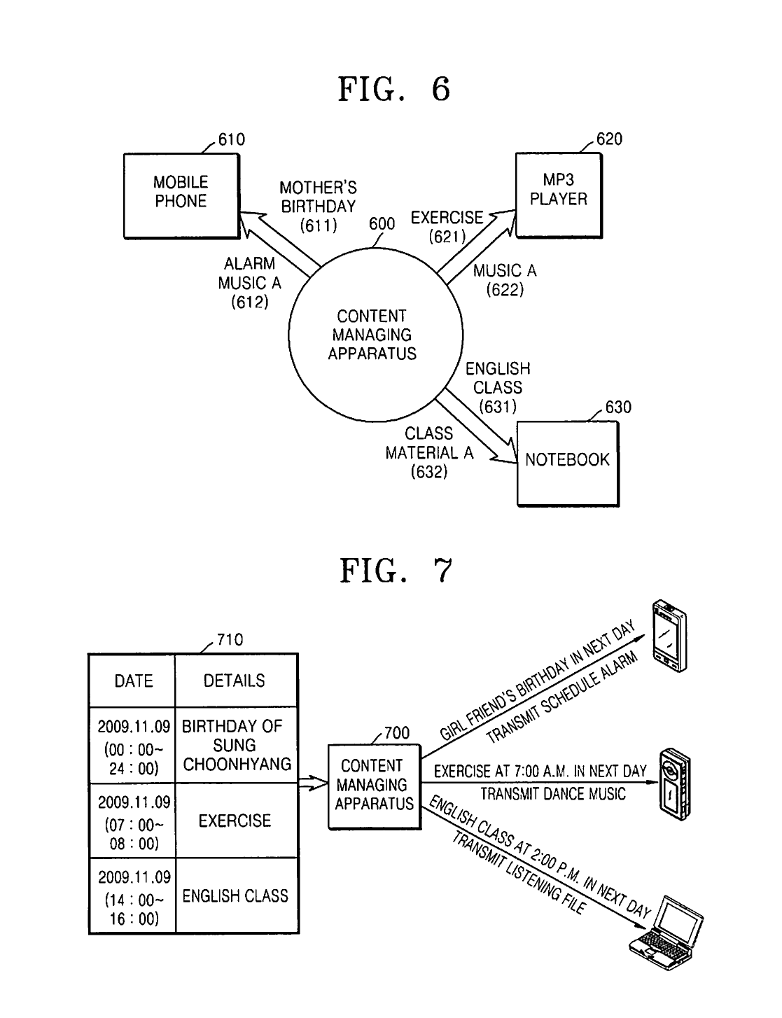

FIG. 6 illustrates an example of operations performed by a content managing apparatus 600 according to an embodiment of the present invention.

As described above, a content selection unit 122 determines content corresponding to an event to occur in the future, based on at least one of user schedule information and user metadata. In the example illustrated in FIG. 6, there are three events will occur, i.e., “mother's birthday” 611, “exercise” 621, and “English class” 631.

The content selection unit 122 selects “alarm music A” 612 as content corresponding to “mother's birthday” 611, selects “dance music A” 622 as content corresponding to “exercise” 621, and selects “class material A” 632 as content corresponding to “English class” 631.

A device selection unit 124 selects one or more external devices to receive “alarm music A” 612, “dance music A” 622, and “class material A” 632. The device selection unit 124 selects a mobile phone 610 for the “alarm music A” 612, selects an MP3 player 620 for the “dance music A” 622, and selects a notebook 630 for the “class material A” 632.

A generation unit 130 generates binding information about binding between an event, content, and an external device. A transmission unit transmits the “alarm music A” 612, “dance music A” 622, and “class material A” 632 to the external devices according to the binding information. Here, a time to transmit content may be set by a user or may be set with a default value.

FIG. 7 illustrates an example of operations performed by a content managing apparatus 700 according to an embodiment of the present invention.

Referring to FIG. 7, the content managing apparatus 700 obtains information about an event to occur in the future from schedule information 710. Referring to the schedule information 710, three events are scheduled on Nov. 9, 2009, i.e., “birthday of Sung Choonhyang”, “exercise”, and “English class”.

Referring to the user metadata 200 of FIG. 2, a user generally listens to dance music for an “exercise” event. In particular, the user mainly listens to “dance music A” for the “exercise” event. The content managing apparatus 700 determines “dance music A” as content corresponding to the “exercise” event.

Referring to the user metadata 200, an English level of the user is “level 3”. The content managing apparatus 700 determines “level-3 English listening file” as content corresponding to an “English class” event.

Referring to the user metadata 200, “Sung Choonhyang” is a girlfriend of the user. The content managing apparatus 700 determines “alarm music A” as content corresponding to a “birthday of Sung Choonhyang” event.

The content managing apparatus 700 selects one or more external devices to use the determined content. Specifically, in the example illustrated FIG. 7, an MP3 player is selected for the “dance music A”, a mobile phone is selected for the “alarm music A”, and a notebook is selected for the “level-3 English listening file”.

The content managing apparatus 700 determines a time to transmit each content, based on the schedule information 710. The content managing apparatus 700 may simultaneously transmit content at a specific time, wherein the content correspond to all events to occur in a next day, or may separately transmit the content within a predetermined time before each event is predicted to occur.

For example, the content managing apparatus 700 may transmit all of the “dance music A”, the “alarm music A”, and the “level-3 English listening file” at any time before 12:00 AM on Nov. 9, 2009, i.e., before the first event to occur that day, or may transmit the “alarm music A” at 6:11:00 PM on Nov. 8, 2009, may transmit the “dance music A” at 6:00 AM on Nov. 9, 2009, and may transmit “level-3 English listening file” at 1:00 PM on Nov. 9, 2009.

FIG. 8 illustrates an example of binding information, according to an embodiment of the present invention.

Referring to FIG. 8, binding information 810 includes information about binding between two scheduled events, content corresponding to the scheduled events, and devices to reproduce the content. It is assumed that a user adds an “English class” event to user's schedule information. Referring to the schedule information, it is possible to predict that the “English class” event will occur from 2:00-4:00 PM on Nov. 9, 2009.

A content selection unit 122 selects content corresponding to the “English class” event. For example, the content selection unit 122 selects an English listening file as the content corresponding to the “English class” event.

A device selection unit 124 then selects an external device to reproduce the English listening file. For example, the device selection unit 124 selects a notebook as the external device.

A generation unit 130 then generates second binding information 820 by modifying the first binding information 810.

FIG. 9 is a flowchart illustrating a method of managing content, according to an embodiment of the present invention.

Referring to FIG. 9, in step S910, an event to occur in the future is determined based on user metadata. As described above, the user metadata may include at least one of schedule information, user profile information, content preference information, and device preference information.

In step S920, content corresponding to the event, and an external device to reproduce the content are selected. For example, when “exercise” is determined as an event, “dance music” is selected as a type of content corresponding to the event, or when “class” is determined as an event, “listening file” is selected as a type of content corresponding to the event.

Next, content corresponding to the selected type is selected based on content metadata. As described above, the content metadata may include at least one of ID information about usable content, storage location information about the usable content, and authority information about the usable content.

Thereafter, an external device capable of reproducing selected content is selected according to device metadata. As described above, the device metadata may include at least one of ID information about a usable device, device resource status information about the usable device, device codec information about the usable device, video-type information about the usable device, and audio-type information about the usable device.

If one or more external devices are capable of reproducing the selected content, a user most preferred external device is selected according to the user metadata.

In step S930, binding information is generated about a binding between the event, the content, and the external device. Afterward, the selected content may be transmitted to the selected external device based on the binding information, or information that is necessary to obtain the selected content may be transmitted to the selected external device. The selected content may be transmitted to the selected external device within a predetermined time before the determined event is predicted to occur.

In addition to the description provided above, various embodiments of the present invention can be written as computer programs and can be implemented in general-use digital computers that execute the programs using a computer readable recording medium. In addition, a data structure used in the embodiments of the present invention can be written in a computer readable recording medium through various means. Examples of the computer readable recording medium include magnetic storage media (e.g., ROM, floppy disks, hard disks, etc.), optical recording media (e.g., CD-ROMs, or DVDs), etc.

While the present invention has been particularly shown and described with reference to certain embodiments thereof, it will be understood by those of ordinary skill in the art that various changes in form and details may be made therein without departing from the spirit and scope of the invention as defined by the appended claims and their equivalents.

What is claimed is:

1. A method of managing content in a content managing apparatus, the method comprising:
determining an event to occur, based on user metadata;
selecting content corresponding to the event;
selecting an external device to reproduce the content; and
generating binding information about a binding between the event, the content, and the external device.

2. The method of claim 1, further comprising transmitting the content to the external device.

3. The method of claim 2, wherein the content is transmitted to the external device a predetermined time before the event is determined to occur.

4. The method of claim 1, wherein the content is selected based on at least one of content metadata including information about the content and the user metadata, and
wherein the external device is selected, based on at least one of device metadata including information about the external device and the user metadata.

5. The method of claim 4, wherein selecting the content comprises:
determining a type of the content corresponding to the event, based on the user metadata; and
selecting the content corresponding to the type, based on at least one of the user metadata and the content metadata.

6. The method of claim 4, wherein the device metadata includes at least one of identification information about a usable device, resource status information about the usable device, codec information about the usable device, video-type information about the usable device, and audio-type information about the usable device.

7. The method of claim 4, wherein the content metadata includes at least one of identification information about usable content, storage location information about the usable content, and authority information about the usable content.

8. The method of claim 1, wherein the user metadata includes at least one of user schedule information, user profile information indicating personal information of a user, content preference information indicating user preferred content, and device preference information indicating a user preferred device.

9. The method of claim 1, further comprising receiving the content in the content managing apparatus via a network connection.

10. A content managing apparatus comprising:
an event determination unit for determining an event to occur, based on user metadata;
a selection unit for selecting content corresponding to the event, and selecting an external device to reproduce the content; and
a generation unit for generating binding information about a binding between the event, the content, and the external device.

11. The content managing apparatus of claim 10, further comprising a transmission unit for transmitting the content to the external device.

12. The content managing apparatus of claim 11, wherein the transmission unit transmits the content a predetermined time before the event is determined to occur.

13. The content managing apparatus of claim 10, wherein the selection unit comprises:
a content selection unit for selecting the content based on at least one of content metadata including information about the content and the user metadata; and
a device selection unit for selecting the external device based on at least one of device metadata including information about the external device and the user metadata.

14. The content managing apparatus of claim 13, wherein the content selection unit comprises:
a type determination unit for determining a type of the content corresponding to the event, based on the user metadata; and
a content determination unit for selecting the content corresponding to the type, based on at least one of the user metadata and the content metadata.

15. The content managing apparatus of claim 13, wherein the device metadata comprises at least one of:
identification information about a usable device;
resource status information about the usable device;
codec information about the usable device;
video-type information about the usable device; and
audio-type information about the usable device.

16. The content managing apparatus of claim 13, wherein the content metadata comprises at least one of:
identification information about usable content;
storage location information about the usable content; and
authority information about the usable content.

17. The content managing apparatus of claim 10, wherein the user metadata comprises at least one of:
user schedule information;
user profile information indicating personal information of a user;
content preference information indicating user preferred content; and
device preference information indicating a user preferred device.

18. The content managing apparatus of claim 10, further comprising a receiving unit for receiving the content via a network connection.

19. A non-transitory computer readable recording medium having recorded thereon a program for executing the method of:
determining an event to occur, based on user metadata;
selecting content corresponding to the event;
selecting an external device to reproduce the content; and
generating binding information about a binding between the event, the content, and the external device.
